(19) United States
(12) Patent Application Publication
(10) Pub. No.: US 2003/0011326 A1
(43) Pub. Date: Jan. 16, 2003

(54) Fluorescent lamp brightness controller

(76) Inventor: Shi Youl Noh, Seoul (KR)

Correspondence Address: Cooper & Dunham, LLP, 1185 Avenue of the Americas, New York, NY, 10036, US

(21) Appl. No.: 09/904,647

(22) Filed: Jul. 13, 2001

(51) Int. Cl. H05B 37/02

(52) U.S. Cl. 315/291; 315/307

(57) ABSTRACT

A fluorescent lamp brightness controller is disclosed. The fluorescent lamp brightness controller according to the present invention has an advantage of enabling a dimming stabilizer for controlling a brightness of a fluorescent lamp to be normally operated even under a low illumination or under a state the brightness is controlled to approximately 1% of the maximum brightness. The fluorescent lamp brightness controller has a power supplying unit and a resonance circuit for a user to receive a dimming signal controlled by a dimming control unit, through which a user controls the brightness of the fluorescent lamp, and to control the brightness of the fluorescent lamp by means of a lamp operating part. The controller includes a brightness control part for compensating for a temperature value lower than a predetermined level of a peripheral temperature by the dimming signal of the fluorescent lamp brightness with the dimming signal being controlled by the dimming control unit, a lamp malfunction existence detecting part for detecting a source voltage supplied to the fluorescent lamp by means of the lamp operating part to detect whether there exists a malfunction in the fluorescent lamp, and outputting a control signal for controlling a bias power source of the fluorescent lamp, a control part for controlling the brightness of the fluorescent lamp by the signal output from the lamp malfunction existence detecting part and the brightness control part and simultaneously controlling the fluorescent lamp to be turned on/off, and a filament power control part.

### BACKGROUND OF THE INVENTION

1. Field of the Invention

The present invention relates to a fluorescent lamp brightness controller, and more particularly, to a fluorescent lamp brightness controller, which can compensate a fluorescent lamp, whose brightness is controlled by a dimming signal, for an abnormal operation at a temperature lower than a predetermined temperature, and automatically control the brightness of the fluorescent lamp according to a peripheral brightness around the fluorescent lamp as well as detecting whether there exists something wrong in the fluorescent lamp by inducing a current flowing into the fluorescent lamp.

2. Background of the Related Art

In general, fluorescent lamp brightness controllers control a brightness of a fluorescent lamp by varying a source voltage of a power source supplying unit supplied into the fluorescent lamp by means of a dimming stabilizer, or by conducting a phase control.

In the conventional fluorescent lamp brightness controllers, however, as a peripheral temperature around the fluorescent lamp is decreased, a voltage necessary for turning on the lamp is increased and a voltage of a filament is accordingly increased. At this time, unless an energy flowing into the filament is controlled, only the filament would become red-hot. The conventional fluorescent lamp brightness controllers have a disadvantage that the thinner a tube of the fluorescent lamp is, the more difficult the dimming control is.

### SUMMARY OF THE INVENTION

Accordingly, the present invention is directed to a fluorescent lamp brightness controller that substantially obviates one or more problems due to limitations and disadvantages of the related art.

An object of the present invention is to provide a fluorescent lamp brightness controller, which can control a brightness up to approximately 1% of the maximum brightness under a condition where a peripheral temperature is low, by compensating for a temperature value detected by a temperature sensor, which senses the peripheral temperature around the fluorescent lamp.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a fluorescent lamp brightness controller having a power supplying unit and a resonance circuit for a user to receive a dimming signal controlled by a dimming control unit, which controls a brightness of a fluorescent lamp, and to control the brightness of the fluorescent lamp by means of a lamp operating part, the controller including a brightness control part for compensating for an abnormal operation at a temperature lower than a predetermined temperature of a peripheral temperature by the dimming signal of the fluorescent lamp brightness controlled by the dimming control unit; a lamp malfunction existence detecting part for detecting a source voltage supplied to the fluorescent lamp by means of the lamp operating part to detect whether there exists a malfunction in the fluorescent lamp, and outputting a control signal for controlling a bias power source of the fluorescent lamp; and a control part for controlling the brightness of the fluorescent lamp by the signal output from the lamp malfunction existence detecting part and the brightness control part and simultaneously controlling the fluorescent lamp to be turned on/off.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a block diagram showing a configuration of a fluorescent lamp brightness controller according to the present invention;

FIG. 2 illustrates a detail circuit diagram of a fluorescent lamp brightness control part according to the present invention;

FIG. 3 illustrates a detail circuit diagram of a fluorescent lamp operating part according to the present invention; and

FIG. 4 illustrates a detail circuit diagram of a fluorescent lamp malfunction existence detecting part according to the present invention.

### DETAILED DESCRIPTION OF THE INVENTION

Reference will now be made in detail to the preferred embodiment of the present invention, examples of which are illustrated in the accompanying drawings.

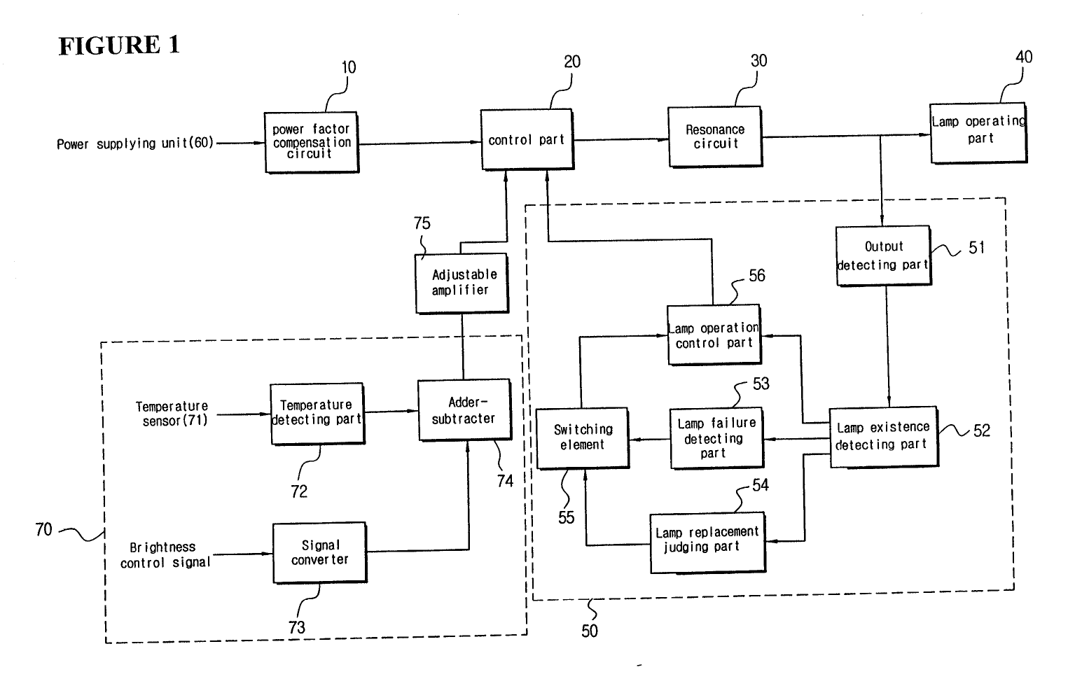

FIG. 1 illustrates a block diagram showing a configuration of a fluorescent lamp brightness controller according to the present invention.

Referring to FIG. 1, the fluorescent lamp brightness controller comprises a power factor compensation circuit 10 being operated by a source voltage supplied by a power source supplying unit 60 for compensating for a power factor of the source voltage; a control part 20 for controlling an operation according to a fluorescent lamp brightness and a lamp malfunction existence; a resonance circuit 30 for operating a fluorescent lamp by an output signal of the control part 20; a lamp operating part 40 for turning on the fluorescent lamp by means of an operating power source supplied from the resonance circuit 30; a lamp malfunction existence detecting part 50 for detecting whether there exists a malfunction in the fluorescent lamp; and a brightness control part 70 for compensating for a temperature and a dimming signal of the brightness of the fluorescent lamp inputted from the outside.

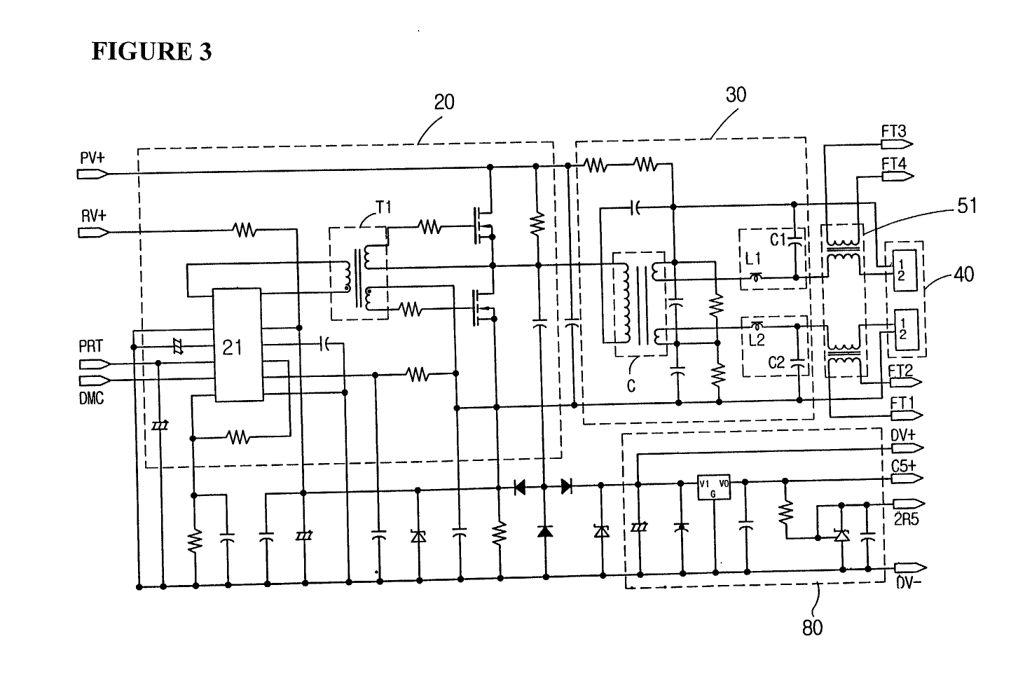

A constant voltage circuit 80 (see FIG. 3) for operating an electric circuit element is further installed inside the fluorescent lamp brightness controller to convert an AC power source into a DC power source and supply the DC power source.

The brightness control part 70 includes a temperature detecting part 72 for detecting a peripheral temperature value around the fluorescent lamp by a signal sensed by a temperature sensor 71, which detects the peripheral temperature around the fluorescent lamp; a signal converter 73 for converting the dimming signal of the fluorescent lamp brightness, the dimming signal being controlled by a dimming circuit which is controlled by a user, into an electrical signal; and an adder-subtracter 74 for compensating for an abnormal operation due to the peripheral temperature and an error due to a peripheral brightness by the signal inputted by the temperature detecting part 72 and the signal converter 73.

The lamp malfunction existence detecting part 50 includes a lamp output detecting part 51 for detecting the operating power source supplied to the fluorescent lamp of the lamp operating part 40; a lamp existence detecting part 52 for detecting whether there exists the fluorescent lamp operated by the operating power source detected by the lamp output detecting part 51; a lamp failure detecting part 53 for detecting whether there exists a failure in the fluorescent lamp by the signal detected by the lamp existence detecting part 52; a lamp replacement judging part 54 for judging whether there exists a replacement by the signal detected by the lamp existence detecting part 52; a switching element 55 for switching an output signal if the fluorescent lamp is replaced by the signal detected by the lamp replacement judging part 54; and a lamp operation control part 56 for outputting a turning on-off signal of the fluorescent lamp by the signal switched by the switching element 55.

As for operation of the fluorescent lamp brightness controller, the fluorescent lamp brightness controller increases the power factor of the source voltage by means of the power factor compensation circuit 10 which compensates for the power factor of the source voltage supplied from the power source supplying unit 60, and then supplies the stabled source voltage to a bias power source of the resonance circuit 30 and the control part 20.

The control part 20 supplies the operating signal for operating the resonance circuit 30 by the source voltage supplied through the power factor compensation circuit 10, and the resonance circuit 30 operates the fluorescent lamp of the lamp operating part 40 through an R-L-C resonance by the signal inputted by the control part 20. Since coils L1 and L2 of the resonance circuit 30 need a higher electric power when the fluorescent lamp is turned on, core saturation characteristic of the coils L1 and L2 should be optimized, so that if a current over a predetermined level is supplied, impedance is adapted to be drastically reduced, and condensers C1 and C2 prevent a tremor of light under a low illumination and exclude an over-current from being supplied to a filament under the low illumination by shifting a phase of the source voltage.

In the event that the fluorescent lamp of the lamp operating part 40 is not operated, the lamp malfunction existence detecting part 50 for detecting the operating power source supplied to the fluorescent lamp detects whether there exists the malfunction in the fluorescent lamp.

That is to say, if the resonance circuit 30 is operated, the lamp output detecting part 51 for detecting the fluorescent lamp operating power source supplied to the lamp operating part 40 detects the operating power source of the fluorescent lamp. Thereafter, the lamp existence detecting part 52 for detecting the fluorescent lamp existence detects whether there exists the fluorescent lamp.

If it is detected that there does not exist the fluorescent lamp by the signal detected by the lamp existence detecting part 53, the lamp existence detecting part 52 outputs an “L” signal to the lamp operation control part 56. The lamp operation control part 56 outputs a “H” signal to exclude the resonance circuit 30 from being operated and turn off the fluorescent lamp of the lamp operating part 40.

Next, since the lamp replacement judging part 54 judges that the fluorescent lamp is not replaced, it outputs the “L” signal to exclude the bias power source of the switching element 55. Also, since the lamp failure detecting part 53 judges that there exists a failure in the fluorescent lamp, it outputs the “L” signal to exclude the operating power source of the switching element 55. Since the output of the switching element 55 is excluded, the lamp operation control part 56 keeps a state that the fluorescent lamp is turned off.

As for the brightness control and the temperature compensation of the fluorescent lamp, if the user 55 controls the brightness of the fluorescent lamp by means of the fluorescent lamp brightness control unit, the dimming signal of the brightness of the fluorescent lamp is inputted to the signal converter 73, and then the signal converter 73 converts the fluorescent lamp brightness information into the electrical signal by the dimming signal of the fluorescent lamp brightness and supplies the electrical signal to an adder-subtracter 74. The temperature signal sensed by the temperature sensor 71 which senses the peripheral temperature around the fluorescent lamp is inputted to the temperature detecting part 72 and then the temperature detecting part 72 supplies the peripheral temperature value around the fluorescent lamp to the adder-subtracter 74.

The adder-subtracter 74 compensates for the temperature value through an adjustable amplifier 75 by the fluorescent lamp brightness signal inputted from the signal converter 73 and inputs the compensated temperature value to the control part 20.

Therefore, the control part 20 controls the brightness of the fluorescent lamp by the inputted signal according to the dimming signal of the fluorescent lamp brightness.

A detail configuration of the fluorescent lamp brightness controller according to the present invention will be explained herein below with reference to FIGS.

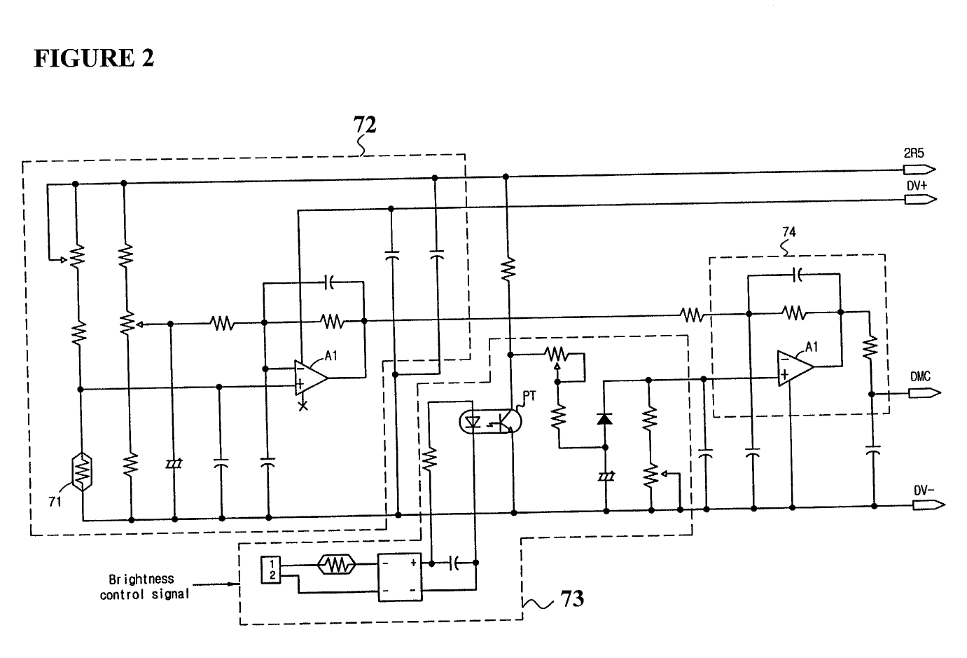

FIG. 2 illustrates a detail circuit diagram of the fluorescent lamp brightness compensation circuit according to the present invention.

As shown in FIG. 2, the fluorescent lamp brightness control part 70 initially inputs a resistance value to the temperature detecting part 72 by the temperature value sensed by the temperature sensor 71, such as a thermistor, which has a varying resistance value according to the temperature.

Furthermore, the temperature detecting part 72 inputs a temperature value preset by a variable terminal of a variable resistance VR1 to one side of an amplifier A1 of the temperature detecting part 72, compares the preset temperature value with the resistance value inputted by the temperature sensor 71, and inputs a current temperature value to the adder-substracter 74.

If the user controls the brightness of the fluorescent lamp by means of the fluorescent lamp brightness control unit, the controlled dimming signal is inputted to the signal converter 73. The signal converter 73 controls an operation of a photodetection element PT, which detects the peripheral brightness around the fluorescent lamp, by the dimming signal, compensates for the peripheral brightness around the fluorescent lamp, and supplies the compensated peripheral brightness to the adder-subtracter.

The adder-substracter 74 compares the two inputted signals, namely, the current temperature value and the compensated peripheral brightness, adds-substracts the inputted signals to compensate for the temperature value and the peripheral brightness by the comparison, amplifies the added-subtracted signals by means of an amplifier A2, and inputs the fluorescent lamp brightness signal to the control part 20.

FIG. 3 illustrates a detail circuit diagram of the fluorescent lamp operating part according to the present invention.

As shown in FIG. 3, the control part 20 controls the dimming controller 21 to judge the brightness of the fluorescent lamp by the fluorescent lamp brightness signal inputted from the adder-subtracter 74, and outputs the pertinent dimming signal, which passes through a transformer T1 of the control part 20 and is inputted to the resonance circuit 30.

The dimming signal inputted to the resonance circuit 30 is induced to a choke coil C. At this time, the dimming signal induced to the choke coil C performs a phase control of the DC power source, an interference prevention of the DC power source, and an over-current flow prevention, and then is inputted to the lamp operating part 40 to operate the fluorescent lamp, thereby controlling the brightness of the fluorescent lamp. Here, if a higher power is necessary for turning on the fluorescent lamp, the impedance is drastically reduced by virtue of the saturation characteristic of the coils L1 and L2, thereby enabling to supply the higher power. In such a case that the dimming control is carried out under a low illumination, if a frequency is increased during the dimming control, the impedance becomes increased by virtue of the characteristic of the coils L1 and L2, whereby the power flowing into the fluorescent lamp operating part 40 is controlled and the brightness is controlled irrespective of thickness of the fluorescent lamp tube.

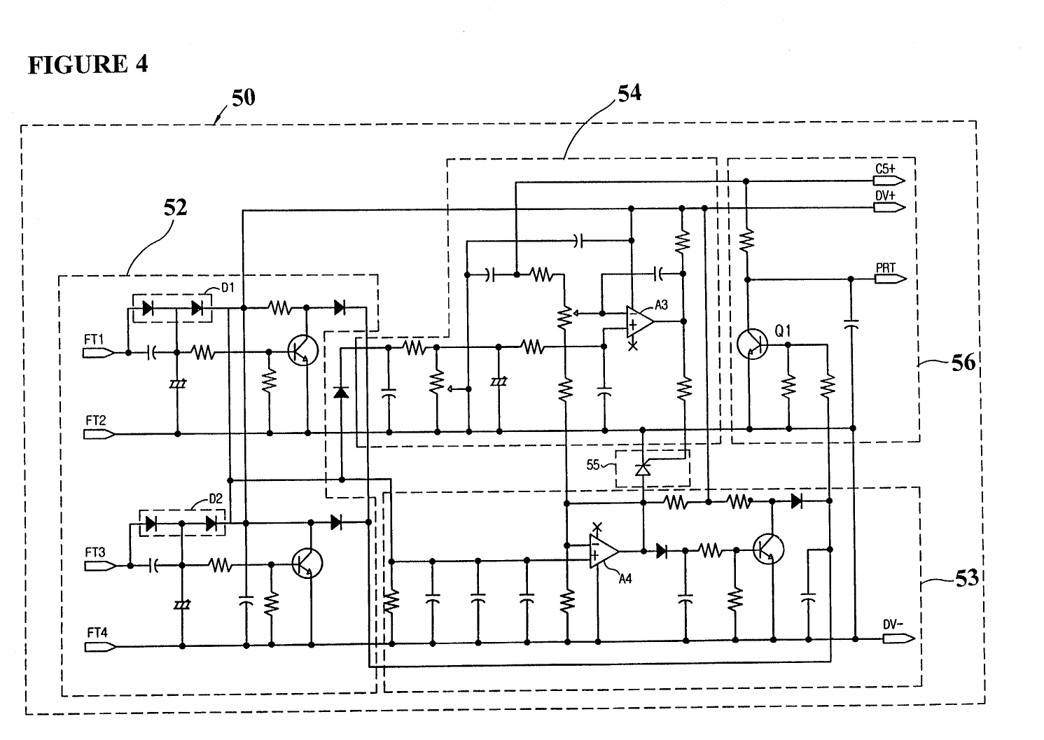

FIG. 4 illustrates a detail circuit diagram of the lamp malfunction existence detecting part according to the present invention.

As illustrated in FIG. 4, the lamp malfunction existence detecting part 50 for detecting whether there exists a malfunction in the fluorescent lamp induces a current flowing to both ends of the fluorescent lamp and detects whether there exists the malfunction in the lamp. That is to say, the lamp malfunction existence detecting part 50 induces the “H” signal when the fluorescent lamp is turned on by the lamp output detecting part 51 (see FIG. 3) while induces the “L” signal when the fluorescent lamp is turned off.

If the “H” signal is induced, the current induced by the lamp output detecting part 51 flows into diodes D1 and D2 at both ends of the lamp existence detecting part 52, and simultaneously supplied to the bias power source of the lamp operating control part 56 to operate a transistor Q1, whereby the “H” signal is output to the dimming controller 21 of the control part 20, and the dimming controller 21 maintains the state that the fluorescent lamp is turned-on.

Meantime, in the event that the fluorescent lamp is in the turned-on state or the lamp is removed (at one side or both sides), if the “L” signal is induced, the current induced by the lamp output detecting part 51 is excluded from flowing to the diodes D1 and D2 at the both ends of the lamp existence detecting part 52, and simultaneously is supplied to the bias power source of the lamp operation control part 56 to operate the transistor Q1, whereby the “L” signal is output to the dimming controller 21 of the control part 20 connected to a collector of the transistor Q1, and the dimming controller maintains the state that the fluorescent lamp is removed.

If there exits the failure in the lamp, the current induced by the lamp output detecting part 51 is increased, causing a higher voltage than that in a normal condition. As a result, an inversion amplifier A3 of the lamp replacement judging part 54 for detecting whether there exists a failure in the lamp is operated, the switching element 55 starts to be operated, and the transistor Q1 of the lamp operation control part 56 is turned on, consequently preventing the over-current of the stabilizer from being caused due to the lamp failure.

Moreover, if the user replaces the fluorescent lamp, the “H” signal instead of the “L” signal is inputted to the lamp existence detecting part 52, and hence the transistor Q1 of the lamp operation control part 56 is not operated. Accordingly, the “H” signal is inputted to the control part 20 and the fluorescent lamp maintains the current state.

However, if the “L” signal is supplied to the lamp replacement judging part 54, the inversion amplifier A3 which supplies the inversed output is not operated, and the operation of the switching element 55 is canceled, whereby the transistor Q1 of the lamp operation control part 56 maintains the “H” signal, serving to turn on the fluorescent lamp through the control part 20.

As stated above, the present invention has an advantage of ensuring a normal operation of the dimming stabilizer, which controls the brightness of the fluorescent lamp, even when there exists the malfunction in turning on the fluorescent lamp under the low illumination, or when the brightness is controlled to approximately 1% of the maximum brightness. The present invention has another advantage of protecting the stabilizer, since the fluorescent lamp is automatically turned on when it is replaced because of the failure thereon, and the brightness compensation control is achieved with respect to a low temperature in a cold weather during winder, etc.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A fluorescent lamp brightness controller having a power supplying unit and a resonance circuit for a user to receive a dimming signal controlled by a dimming control unit, through which the user controls a brightness of a fluorescent lamp, and to control the brightness of the fluorescent lamp by means of a lamp operating part, the controller comprising:
a brightness control part for compensating for a temperature value lower than a predetermined level of a peripheral temperature by the dimming signal of the fluorescent lamp brightness controlled by the dimming control unit;
a lamp malfunction existence detecting part for detecting a source voltage supplied to the fluorescent lamp by means of the lamp operating part to detect whether there exists a malfunction in the fluorescent lamp, and outputting a control signal for controlling a bias power source of the fluorescent lamp; and
a control part for controlling the brightness of the fluorescent lamp by the signal output from the lamp malfunction existence detecting part and the brightness control part and simultaneously controlling the fluorescent lamp to be turned on/off.

2. The controller of claim 1, wherein the brightness control part includes:
a signal converter for converting the dimming signal of the fluorescent lamp brightness controlled by the user, into an electrical signal;
a temperature detecting part for detecting a peripheral temperature value around the fluorescent lamp by a temperature sensed by a temperature sensor, which detects the peripheral temperature around the fluorescent lamp; and
an adder-subtracter for adding-subtracting and compensating for the temperature value by the dimming signal of the fluorescent lamp brightness controlled by the signal inputted from the temperature detecting part and the signal converter.

3. The controller of claim 1, wherein the lamp malfunction existence detecting part includes:
a lamp output detecting part for detecting a power source supplied to the fluorescent lamp of the lamp operating part;
a lamp existence detecting part for detecting whether there exists the fluorescent lamp by the signal detected by the lamp output detecting part;
a lamp failure detecting part for detecting whether there exists a failure in the fluorescent lamp by the signal detected by the lamp existence detecting part;
a lamp replacement judging part for judging whether there exists a replacement by the signal detected by the lamp existence detecting part;
a switching element for outputting a signal for supplying and excluding the power source to the fluorescent lamp by the signal judged by the lamp failure detecting part and the lamp replacement judging part; and
a lamp operation control part for outputting a turning on-off control signal of the fluorescent lamp by the signal output from the switching element.
